(19) United States
(12) Patent Application Publication
(10) Pub. No.: US 2019/0050768 A1
(43) Pub. Date: Feb. 14, 2019

(54) Application for Notification & Alerts of Metrics

(71) Applicant: Balasubramanian Cuddalore, Fremont, CA (US)

(72) Inventor: Balasubramanian Cuddalore, Fremont, CA (US)

(21) Appl. No.: 15/673,479

(22) Filed: Aug. 10, 2017

(51) Int. Cl. G06Q 10/06; H04L 12/58; H04W 4/12

(52) U.S. Cl. CPC G06Q 10/0639; H04W 4/12; H04L 51/38; G06Q 10/06375

(57) ABSTRACT

This invention is in the field of Business Intelligence, Analytics, data and data sciences where in the use of this application may enable companies to monitor the performance and/or efficiency of their company processes, activities or their systems, applications, infrastructure that would allow them to maximize revenue, profit, increase customer satisfaction or reduce losses. This document contains the invention specification, drawings and claims.

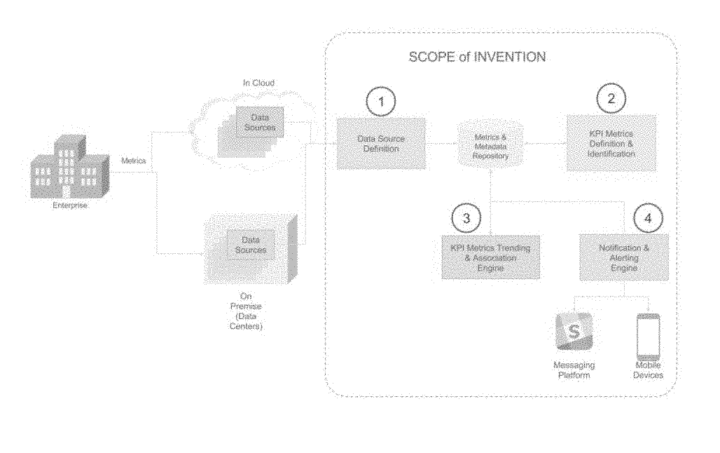

### BACKGROUND

Enterprises rely on internal and third party tools, applications to provide them with insights into their business performance from data that is captured across the systems within. These insights are in the form of measurements identified as Key Performance Indicators or KPI. KPIs are defined by the business to measure how the business is performing and whether or not efficiently. Information Technologists that form the Business Intelligence team and Analysts are usually responsible for gathering, computing and disseminating these KPI or metrics to all stakeholders within a company in the form of reports, dashboards and scorecards.

While these KPI measurements provide information on what is currently going on within the business it is more often than not that these reports, tools and other methods of metric consumption fail to provide actionable insights into why the metrics are trending up or down.

Almost often, key decision makers are not always looking at the right reports or scorecards to launch investigation into any metric upswing or downtrend. The sheer amount of information fed to them also makes it impossible for them to find the right amount of time to discern these metrics let alone find answers to make critical decisions. In addition, it takes time for a band of analysts to investigate into why and this takes time.

As a result, enterprises find themselves in a situation wherein it is too late to rectify poor business performance or efficiency which in turn causes losses. Alternatively, they are also unable to repeat superior performance when the metrics are indicating uptrends resulting in lost opportunities.

This invention is expected to solve the above problems and is described in the sections following.

### BRIEF SUMMARY

In the world where time is limited and much information is to be consumed, this invention is slated to bring the right amount of essential insights and reasons for the metric downtrend or uptick for decision makers to act on and make effective, timely decisions. And by making it available on mobile devices and messaging platforms, it can be consumed anywhere, anytime within a matter of minutes providing the ability to make to right decisions at the right time preventing losses or lost opportunities.

With the help of elastic computing capabilities of distributed systems, the application will scour through data within and outside enterprises looking for previously defined, identified KPI or metrics and compute any associations (correlations, causality that are statistically significant) between them using computer algorithms such as Machine Learning and Statistical, Mathematical models.

Having determined the trends of these metrics and their associations, the application then notifies and alerts subscribed stakeholders within an enterprise of what is going on with KPIs and why there is an uptick or downtrend using mobile devices such as a phone, a tablet, or a laptop with connectivity.

### DETAILED DESCRIPTION

Before notifying or alerting metric trends and their associations to other metrics, there are precursory steps that are needed to be taken. These steps are outlined as follows:

Data Source Identification

Every enterprise captures data in a variety of systems and repositories both within their data centers and/or in the cloud. This invention requires these data sources to be identified from where the metrics can be queried.

These data sources will be recorded in a metadata repository for future reference by computer programs that run within this invention.

KPI/Metric Definition & Identification

Since each enterprise measures their business performance and efficiency differently, it would have to define Key Performance Indicators for this invention to find them and to compute these metrics.

These KPI metrics, their definition, computation algorithms, and identification as KPI are recorded in a metadata repository for future reference by computer programs running within this invention.

KPI Trending & Associations

Within the scope of this invention, a series of computer programs will be scheduled to run on a periodic basis to read KPI metrics from the metadata repository built in the previous steps above.

These series of computer programs will identify KPI metric trends over time periods defined such as daily, weekly, monthly, quarterly and/or yearly to determine upward and downward trends. Having done that, computer programs will also determine association of these trends to other metrics as the possible reasons for upticks or downtrends using machine learning and statistical, mathematical algorithms.

The results of these trends and subsequent reasons for the trend will be recorded into a data repository.

Notification & Alerts

A notification engine comprising of several computer programs and applications (mobile) will read from the recorded trends & associations data repository to alert the subscriber of the recent trends in the KPI and the possible reasons for their trends based on subscriber preferences.

This would allow key decision makers and their teams to follow up on the right reasons and to rectify or to continue execution to increase growth, performance and efficiencies of their businesses.

### KPI Identification & Recording

1. KPI and metrics identification through manual or automated methods and recording them in a data repository for future reference. By manual methods, delegated agents of an enterprise can identify and configure the enterprise's key metrics or KPI through a web interface. Automated methods would include a series of computer programs run against an enterprise's data sources and identify, assimilate key metrics or KPI that is then stored in a repository.
KPI Trending & Association Algorithms
A series of computer programs run in a sequence, read the already calculated metrics and KPI from the data repository and their trends over time periods. Time periods can be daily, weekly, biweekly, monthly, quarterly and or yearly. The trends of these metrics are then compared with previous time periods using mathematical and statistical algorithms written with these computer programs. The relationships and associations between these metrics and their impact to each other is established and recorded in a data repository.
Algorithms used to compute relationships will save models that can be used to calculate projected values in the future. Algorithms will also be able to select the best model to compute projected value using Machine Learning techniques.
Notification and Alerting of Metric Trends with Associations and Causality on Mobile Devices, Messaging Platforms
Having established associations between metrics and how they impact each other, the causality of the trends observed of these metrics is then reported out as notifications or alerts on to Mobile devices including but not limited to phones, tablets, laptops or other portable devices. or messaging platforms such as Slack.
Notifications include trends, causality of trends, projected value of metrics, targets established by the enterprises for the defined metrics, variance between Actual & Target and variance between projected values and targets.
Notification will also include recommended actions to take to improve or sustain metric trends using algorithms, neural networks and machine/deep learning methodologies.
